(19) United States
(12) Patent Application Publication
(10) Pub. No.: US 2011/0276552 A1
(43) Pub. Date: Nov. 10, 2011

(54) RECONSTRUCTION OF TRANSIENT INFORMATION IN INFORMATION DELIVERY SYSTEMS

(75) Inventors: Shoshana K. Loeb, Philadelphia, PA (US); Euthimios Panagos, Madison, NJ (US)

(73) Assignee: TELCORDIA TECHNOLOGIES, INC., Piscataway, NJ (US)

(21) Appl. No.: 12/775,700

(22) Filed: May 7, 2010

(51) Int. Cl. G06F 17/30

(52) U.S. Cl. 707/706; 707/769; 707/737; 707/E17.014; 707/E17.046; 707/E17.108

(57) ABSTRACT

In a dynamic information delivery context, a system collects data regarding transient information accessed by a user. The user can then query the stored data to reconstruct transient information. The system uses heuristics to help reconstruct transient information. The heuristics include user profile, time stamps, metadata, and indexing.

### FIELD OF ME INVENTION

The invention relates to customizing a user experience of a dynamic information delivery system.

### BACKGROUND

In dynamic information delivery systems, such as the Internet, users peruse information. Some information may be requested by the user, but other information may be delivered by content providers for purposes of their own. For instance, a website may display an advertisement (ad), catalog item, or news story in the hope that a user will click on it, generating revenues for the provider of the website. A website may dynamically customize the display given to a user, based on a profile, targeting news stories, recommendations, or advertisements. Internet browsers, such as Internet Explorer or Mozilla Firefox, retain histories of what the user has seen, so that the user can retrace her steps in browsing. Some browsers and some websites include search engines, such as Google or Bing, for locating information in the information delivery system.

### SUMMARY OF THE INVENTION

The term “transient” is used herein to describe information that is assembled in real time for a user of an information delivery system. The system may take into account various factors that influence what content is to be provided to the user, for example, what ad will be placed. These factors could include: time of day and current events, as well user specific information such as user query, user profile, current user location, and the like.

An information source or information delivery system will be considered “dynamic” herein if it provides transient information.

In the course of investigating dynamic information delivery systems, the inventors here have realized that transient information such as advertisements, recommendations, and news stories are difficult to find again after the user has left the particular configuration where that information was presented. Such information may be temporarily retained by browsers in the form of a cache, i.e., disk space where browsers store contents of recently visited pages. Browsers use the cache for performance reasons by avoiding—under certain conditions—retrieving a page from the Internet when a suitable cached version of the page already exists. The browser cache does not capture the context under which a user visited a particular page in the first place, nor does it expose a mechanism for allowing a user to search for specific dynamic information in it. Transient information is not necessarily locatable using search engines, as the information providers may have assembled the information from dynamic sources, where the source information may not be separately searchable or may no longer be easily available because a fee paid period for presenting it has expired or because the information has been updated.

It is desirable to implement a computer method in which at least one data processing device maintains a record of content presented to a user by at least one dynamic information source. A user information request is received relating to transient information previously presented to the user. Data relating to the transient information is reconstructed responsive to the user information request. The reconstructed data is presented to the user.

It is further desirable to implement a computer method in which a proxy is run between a user and a network. Responsive to the proxy, content experienced by the user is processed. This includes differentiating according to whether such content is transient or expected to be available at a future time. The transient content is then stored for later retrieval by the user.

Advantageously a system including at least one user interface, at least one storage apparatus, and at least one data processing device can implement the above methods.

Further advantageously, a medium can embody computer program code for carrying out the above methods.

Objects and advantages will become clear in the following descriptions and claims.

### BRIEF DESCRIPTION OF THE FIGURES

Embodiments will now be described by way of non-limiting example with reference to the following figures:

FIG. 1 shows an example of a dynamic information delivery system, in particular a laptop connected to a dynamic webpage with multiple sources of information.

FIG. 2 shows components of a system for retaining transient information.

FIG. 3 shows a user management module.

FIG. 4 shows an inferencing engine.

FIG. 5 shows an information processing module, including timestamp, index, and metadata generation capability.

FIG. 6 shows a search engine.

FIG. 7 shows a profile adaptor.

FIG. 8 shows a data source management module.

FIG. 9 shows a flow for a user browsing the web

FIG. 10 shows a flow for a user retrieving an old item.

### DETAILED DESCRIPTION

In the figures, when a reference numeral is repeated, it is intended to refer to the same item.

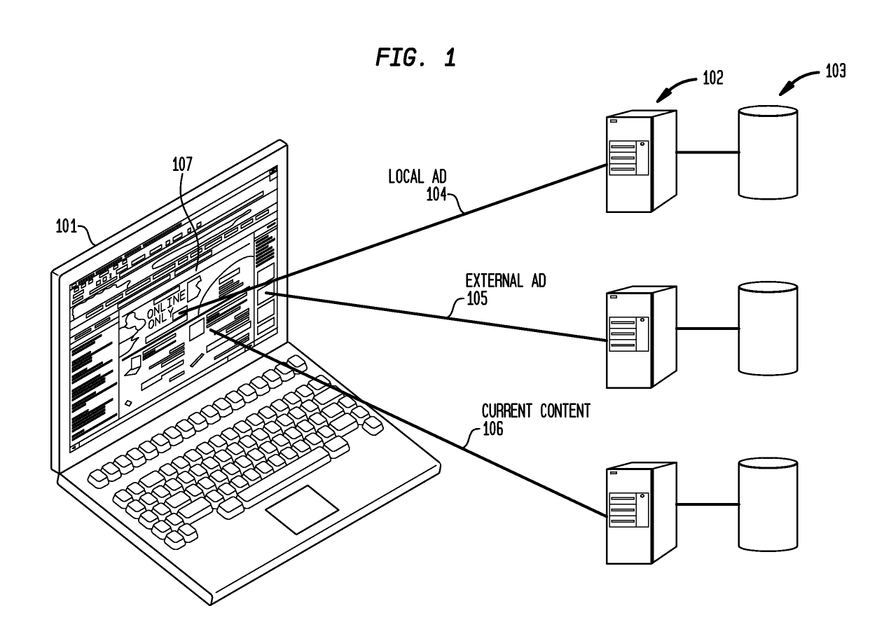

FIG. 1 shows an example of a typical information delivery system. At 101 is a user workstation. In this case, a notebook style computer is illustrated, but this is only an example. Other user devices, such as cell phones, terminals, televisions with set top boxes, or desktop computers, could also be used. This workstation is shown as displaying an Internet web page at 107. The web page includes various content, such as, a local ad 104, an external ad 105, and other current content 106. Each type of content may be sourced from a respective server 102, with its own database 103. This is an example of what is called “mashup paradigm”

This content may be personalized or customized to a user, based on criteria such as user preferences, time, location, and/or other context, in addition to the resources available to a particular website. The criteria leading to a particular assembled display may become complex.

As the movement to personalize information displayed to users has evolved, providers seem not to have completely explored the implications of the transient nature of what is assembled; how a user may not have time to click on all information choices provided at the time of display; and how a user may only think later that he or she wished to have accessed some aspect of the display now gone. Upon return to the website, e.g. by hitting a back button on a browser, the user may be frustrated to see that what is displayed only a few seconds later may be missing desired content.

One example of personalized content might be a print journal that has been converted to a web-based journal. Upon conversion, the journal may decide not to present all stories to all users, but rather to customize which ones are shown to which user. When the journal was in print, it was standardized so that all users saw the same content. Once the journal becomes automated over the Internet, each user may see something slightly different. After the display is over, no one may know what any one user saw.

Another example of personalized content might be a map based system that recommends merchants, such as restaurants, based on user location, time of day, user profile and information or payment provided by merchants. If any of these factors changes, the recommendations presented a few days later might be totally different, leaving the user unable to relocate a preferred merchant.

The user might want to make information requests, such as, the free hotel ad I saw yesterday, the restaurant you recommended last weekend in Freeport, Me., the sale on snow blowers last week, the new book review I read last month, or the doctor I looked up last winter.

It is therefore desirable to create a system adapted to retain or be able to reconstruct transient information. Moreover, it is desirable for the system to be able to respond to requests for such information.

While these examples are Internet based, there might be other information sources that give rise to similar issues, such as proprietary networks within large organizations.

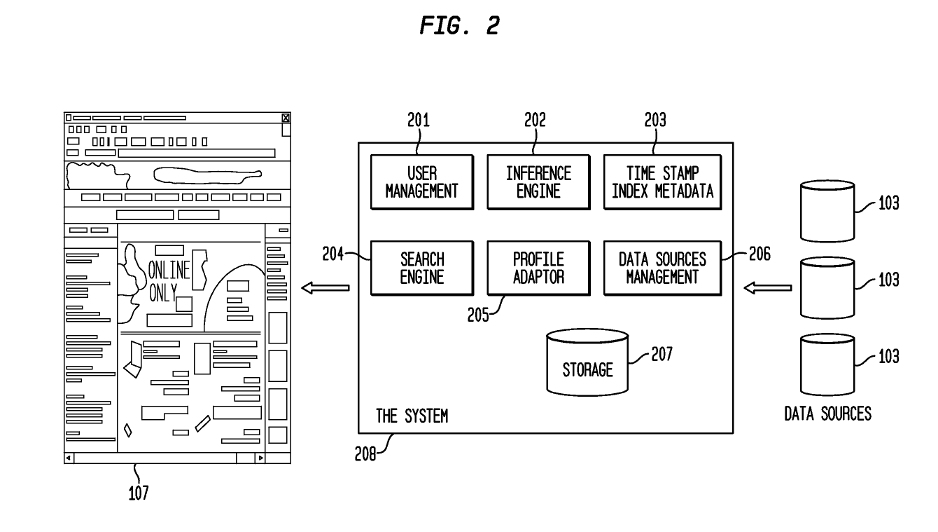

FIG. 2 shows an embodiment of an interface system 208 for gathering transient user information and responding to requests for such information. The system includes various modules, e.g. user management 201; inference engine 202; information processing, including timestamp, index, metadata generation 203; search engine 204; profile adaptor 205; data source management 206.

The system will use some type of storage 207. This storage may be of any suitable type, including magnetic and/or electronic media. Modules may communicate with one another by messaging or they may store data that is read by other modules. More about the interactions of the various elements of the figures will be described below.

The system 208 here might be resident on a single server or distributed throughout multiple servers, or it might be local to a user workstation. The modules shown are merely examples. The functions embodied in those modules might be integrated into a fewer modules or distributed over more modules or divided into different organizational frameworks. Modules might be implemented in software or hardware.

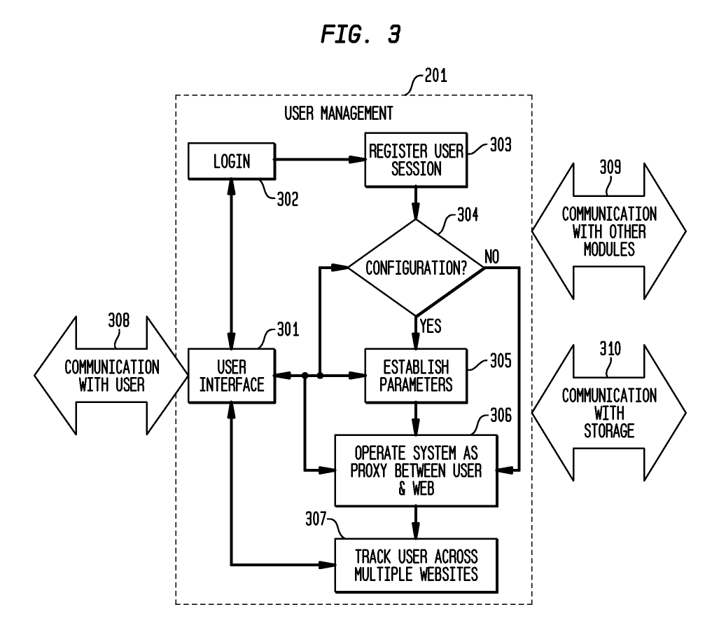

FIG. 3 shows a user management module in more detail. This module communicates with the user at 308 on behalf of other modules that it communicates with at 309. User management may also store some data at 310. Such data may include, for example, copies of pages or page fragments a user visits during a particular session. At 301, a user interface module communicates with the user. After the log in information is gathered at 302, the session is registered with the system at 303. Optionally, the system can ask the user if the user wants to enter configuration information at 304. If the user does want to enter such information, parameters may be established at 305. These parameters might determine what sorts of information the user wants gathered or whether the system is turned on or off. Thereafter, at 306, the system operates as a proxy server between the user and the web. All user requests for web pages are carried out via 306, which requests these pages on behalf of the user from the appropriate data sources. Pages requested by 306 on behalf of a user may be stored by the system via 310, together with additional data such as current user configuration information. When a user requests several web pages from multiple websites during the course of a user session, 307 is responsible for tracking the user across these websites. This is achieved by recording certain information via 310, such as website information and order in which these websites were visited by the user.

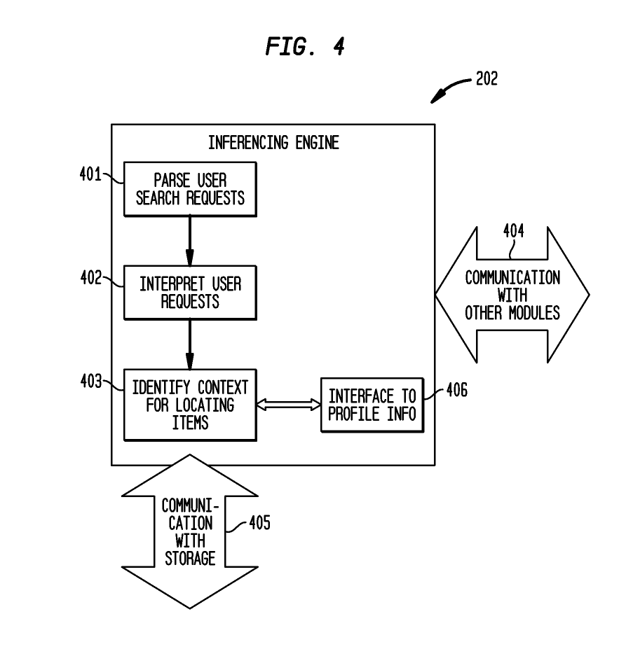

FIG. 4 shows an inferencing engine. This engine communicates with other modules at 404 and with storage at 405. User requests are parsed at 401 in order to extract the parts (e.g., keywords) that are relevant to identifying the context for locating requested items. This is similar to parsing the text entered by users to search engines. Extracted request parts are then interpreted at 402 in order to determine what the user is looking for. Once this is done, then 403 is responsible for identifying the context associated with the user request, such as time, location of user, configuration of the user computer, web content, etc. Interfacing with the profile adapter at 406 can help in this. Context information is retrieved from storage at 405 when this information is not cached in memory.

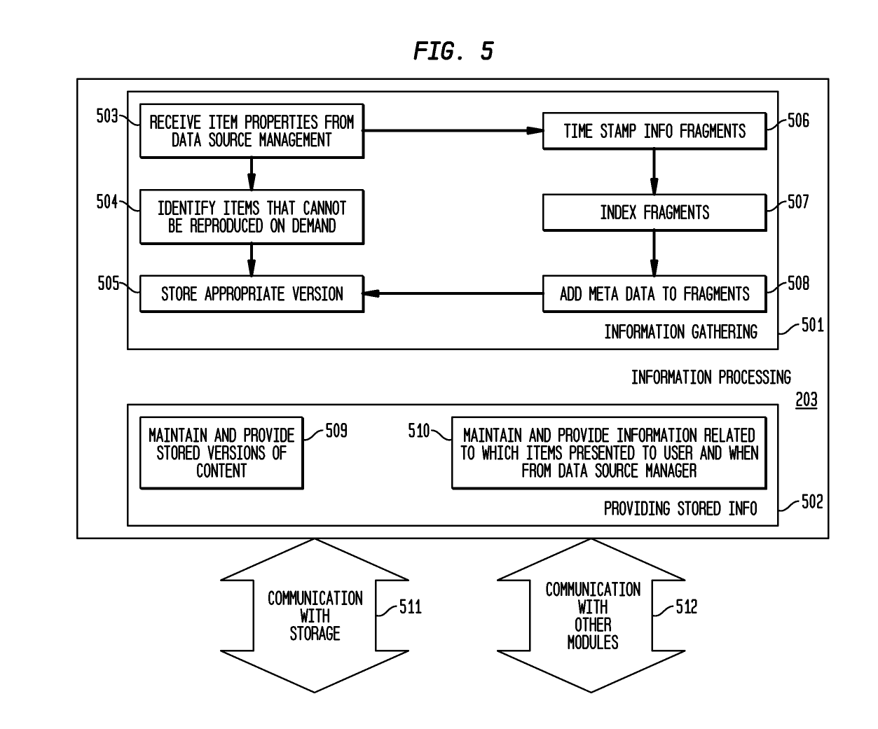

FIG. 5 shows an information processing module 203, which also communicates with storage at 511 and with other modules at 512. Information processing includes two sub-modules, one for gathering information at 501 and one for providing information at 502.

In the information gathering module, item properties are received from data source management at 503. This means that transient content can be identified from currently viewed data. These transient items often will be those identified as not being reproducible on command at 504. Transient items will be identifiable within a web page by parsing the web page and identifying the various components present in it, e.g., images, videos, ads, etc. For each of the identified components, a decision is made on whether this component can be retrieved from the original web site in the future. There are several alternative approaches to making such decisions. One such approach involves a rules-engine that stores rules related to web sites and content in pages served by this web site. At 505, such items that cannot be reproduced on demand, e.g., specific ad images, text, etc., will be stored by the system, so that they can later be retrieved responsive to a user request. In parallel, at 506, items displayed to the user will be time stamped, to facilitate later retrieval that requires access to specific content at a specific time in the past. Various fragments of the items will be indexed at 507 and metadata will be added at 508. Information created in the branch including boxes 506-508 will be stored together with transient items at 505.

At 509 and 510, information generated in box 501 is maintained, for instance in databases, for retrieval by the other modules responsive to user requests.

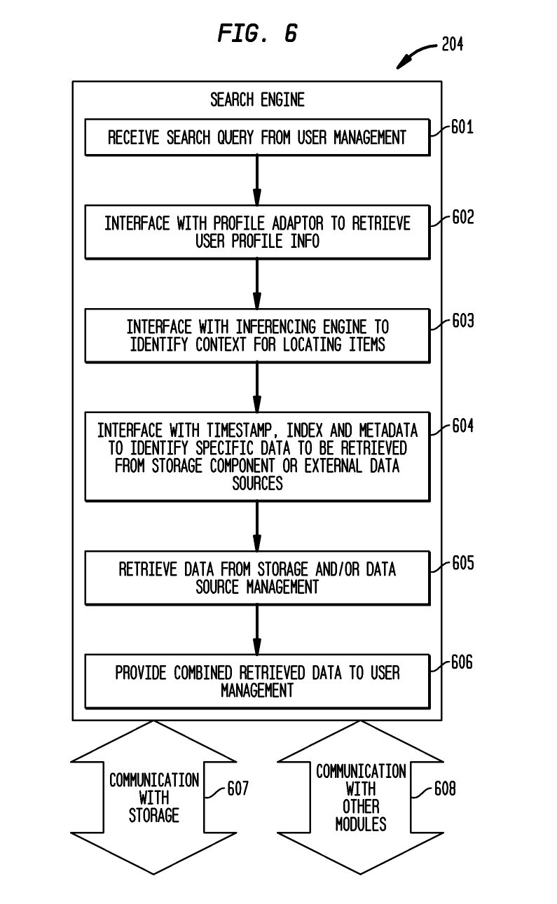

FIG. 6 shows more detail of search engine 204. This module communicates with storage at 607 and other modules at 608. It receives a search query from the user management module at 601. It interfaces with the profile adapter to retrieve user profile information at 602. It interfaces with the inferencing engine to identify context for locating items. It uses timestamp, index, and metadata from the information processing module to identify what is to be retrieved both from system storage or external data sources at 604. At 605, data is retrieved from storage and/or from the data source management module. At 606, combined retrieved data is provided to the user management module to satisfy the search query.

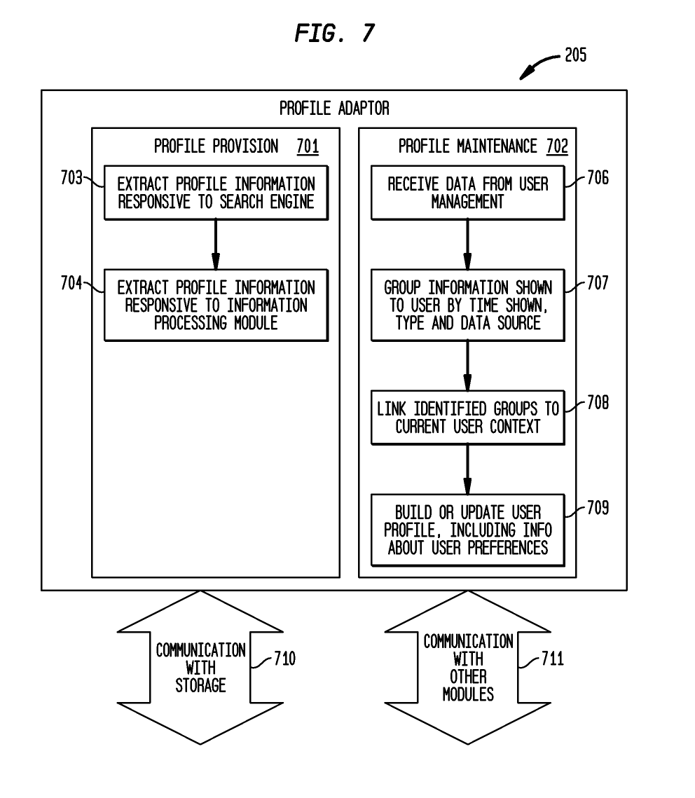

FIG. 7 shows a profile adaptor module 205. This module communicates with storage at 710 and with other modules at 711 and includes two sub-modules, a profile provider 701 and a profile maintainer 702. The profile provider 701 extracts profile information for other modules, such as the search engine at 703, the information processing engine at 704, and the data source manager 705. The extracted information is used for the purpose of identifying the context associated with a specific user request (e.g., show me the free hotel ad I saw yesterday). The information extracted for the data source manager 705 helps identify the web site(s) and content that are relevant to the user request. The profile maintainer 702 receives data from user management at 706, groups information shown to the user by categories, such as time shown, type, and data source at 707. This aggregation is independent of who the user is. The data received from user management at 706 corresponds to the content of the web sites visited by the user. These categories may be derived by processing data from user management or by tags included in the data viewed by the user. At 708 these groups are linked to current user context for a specific user. At 709, it builds a user profile that includes information about user preferences, such as interests in specific topics (e.g., sports, cooking, etc.), product categories (e.g., automobiles, consumer electronics, etc.), events (e.g., concerts, art fairs, etc.).

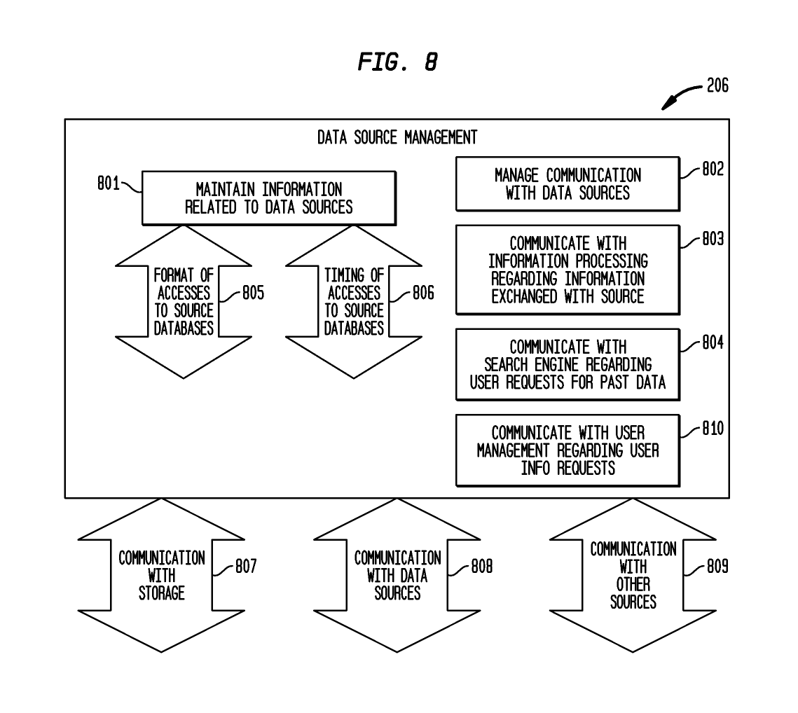

FIG. 8 shows a data source management module 206. This module communicates with storage at 807, with data sources on behalf of other modules at 808, and with other modules at 809. Data source management includes maintaining information relating to data sources at 801. This includes storing information about format and timing of accesses to databases at 805 and 806, such as specific protocol to use, e.g., HTTP; and content encoding, e.g., HTML, XML, image format, etc. The data source manager 206 manages access to external data sources for other modules at 802. There are modules for communicating what is gathered from external data sources such as with the information processing module at 803, with the search engine at 804, and with the user management module at 810.

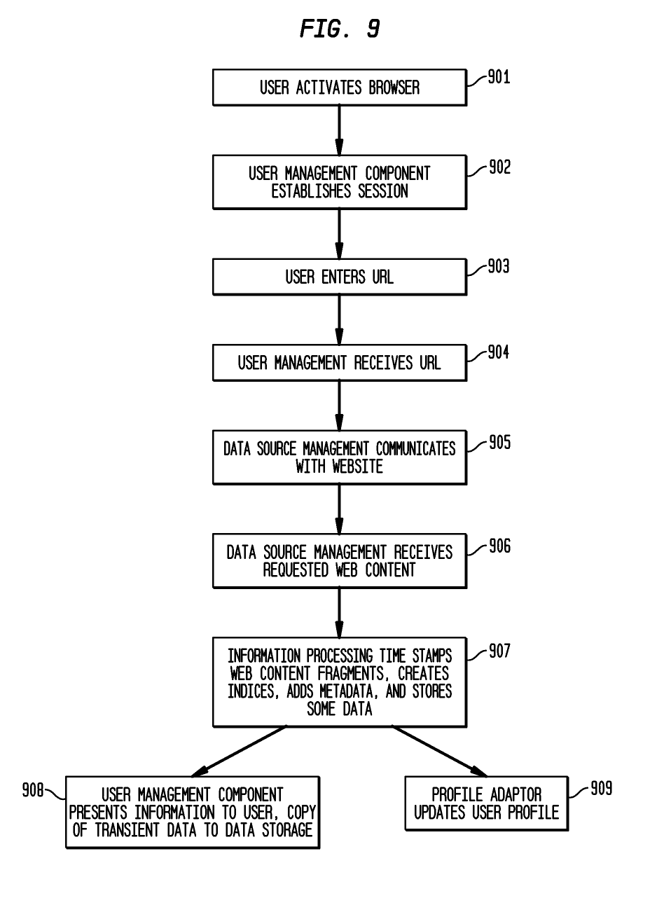

FIG. 9 shows a flow relating to a user using the system during browsing. At 901, user activation of a web browser is detected. At 902, the user management module is activated responsive to activation of the web browser. The user device communicates automatically with the user management component and registers the user session. The system is now a proxy to the communication between the user device and the web. At 903, a user-entered URL is detected. At 904, the user management component receives the URL. At 905, the data source management system issues the request to the website corresponding to the URL. At 906, consequently it receives web content that includes fragments of the page as they come from various sources. At 907, the information processing component time stamps the information fragments, creates appropriate indices, and adds appropriate metadata such as the information source id, the user id, etc.

At 908, the information obtained is then transferred to the user and an abbreviated copy is stored in the system's data storage. At 909, the system updates a user profile using the profile adaptor component.

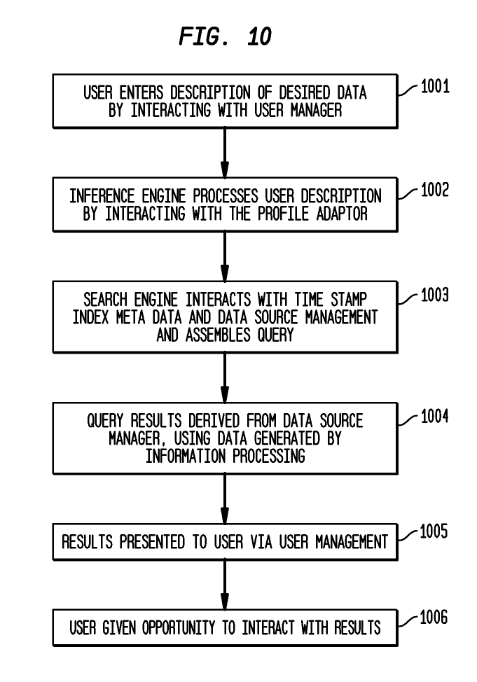

FIG. 10 shows a flow responsive to a user trying to recover data generated in accordance with an earlier session, such as that illustrated in FIG. 9. At 1001, the user management module receives from the user some indication of what data is desired. This indication might take many forms, for instance, the user might specify an exact date and website where he last saw the information, such as: “show me again the Audi A4 ad I saw last Tuesday afternoon”; or the user might specify approximate information, such as: “I remember seeing an article about Google fighting AT&T that had a video but I do not remember where I saw it”.

At 1002, the inference engine processes the user description. This will include interaction with the profile adaptor. At 1003, the search engine assembles a query. In order to do this, it has to interface with the information processing module to retrieve stored timestamp, index, and metadata. The search engine also has to interact data source manager at 1004 before finally assembling a query. This assembly might have diverse implications. For instance, the requested information might be identifiable as something maintained by the information processing module, the requested information might be immediately identifiable as something available through the data source management module, the requested information might not be readily identifiable, so that the inference engine and user profile might be invoked to infer or narrow down the information choices. For example, if the user asks for a book review he read and the profile indicates the user's taste in books, the system can offer to the user the new book reviews on this subject. The system can retrieve these reviews either by searching its internal store or by going out to the web.

At 1004, the data source manager and information processing modules provide responses to the query. Then at 1005 results are presented to the user via the user management module. The user may want to interact with the results at 1006. For instance, if the system does not know exactly what the user is looking for, several avenues of further inquiry might be presented for user selection.

From reading the present disclosure, other modifications will be apparent to persons skilled in the art. Such modifications may involve other features which are already known in the design, manufacture and use of browser interfaces and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”, “comprise”, or “comprises” as used herein should not be viewed as excluding additional elements. The singular article “a” or “an” as used herein should not be viewed as excluding a plurality of elements. Unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Use of ordinal numbers, such as “first” or “second,” is for distinguishing otherwise identical terminology, and is not intended to imply that operations or steps must occur in any particular order, unless otherwise indicated.

Where software or algorithms are disclosed, anthropomorphic or thought-like language may be used herein. There is, nevertheless, no intention to claim human thought or manual operations, unless otherwise indicated. All claimed operations are intended to be carried out automatically by hardware or software. Where human activity is intended herein it is generally qualified with the term “user.”

Where software or hardware is disclosed, it may be drawn with boxes in a drawing. These boxes may in some cases be conceptual. They are not intended to imply that functions described with respect to them could not be distributed to multiple operating entities; nor are they intended to imply that functions could not be combined into one module or entity—unless otherwise indicated.

1. A computer method comprising carrying out operations on at least one data processing device, the operations comprising:
maintaining a record of content presented to a user by at least one dynamic information source;
receiving a user information request relating to transient information previously presented to the user;
reconstructing data relating to the transient information responsive to the user information request; and
presenting reconstructed data to the user.

2. The method of claim 1, wherein the operations comprise:
maintaining a user profile responsive to past user behavior; and
using the user profile to assist in reconstructing the transient information.

3. The method of claim 2, further comprising drawing inferences regarding user context from the user information request and responsive to the user profile.

4. The method of claim 3, wherein the step of reconstructing comprises identifying a proposed transient content query response, responsive to the record and the inferences.

5. The method of claim 4 further comprising steps of:
retrieving non-transient content from at least one external data source;
combining the proposed transient content query response with retrieved non-transient content to yield a combined presentation; and
communicating the combined presentation to the user.

6. The method of claim 1, wherein
the record comprises at least one of a time stamp, indexing information, and metadata; and
reconstructing comprises using the time stamps, indexing, and/or metadata to identify transient information responsive to the information request.

7. The method of claim 1, wherein the user information request comprises a text description of a past time and subject matter.

8. The method of claim 1, further comprising parsing and interpreting the user request.

9. The method of claim 1, wherein the step of reconstructing data comprises:
retrieving stored transient information;
retrieving continuously presented information from an external source as indicated by a stored link; and
combining the stored transient information with the continuously presented information.

10. The method of claim 9, wherein the step of retrieving stored transient information comprises:
parsing a user request;
interpreting the user request; and
identifying a context for locating items.

11. The method of claim 10, wherein the step of reconstructing comprises:
interfacing with an inferencing engine to identify a context for a stored item; and
retrieving stored time stamp, indexing and/or metadata information to help identify specific data corresponding to the user request.

12. A computer method, comprising carrying out operations on a computer, the operations comprising:
running a proxy between a user and a network;
responsive to the proxy, processing content experienced by the user, including differentiating according to whether such content is transient or expected to be available at a future time; and
storing transient content for later retrieval by the user.

13. The method of claim 12, further comprising storing at least one link to content expected to be available.

14. The method of claim 12, further comprising storing at least one of time stamp data, index data, and metadata associated with the transient content.

15. The method of claim 12, wherein differentiating comprises communicating with a website providing currently viewed content regarding sources of the currently viewed content.

16. The method of claim 12, further comprising tracking a user across multiple websites.

17. The method of claim 12, comprising building or updating a user profile based on results from the proxy.

18. The method of claim 17, comprising:
grouping content experienced by the user to yield groups of content;
linking the groups of content to a current user context; and
wherein the building or updating is responsive to the grouping and linking.

19. A system comprising:
at least one user interface;
at least one data storage apparatus;
at least one data processing device adapted to carry out operations, the operations comprising:
maintaining a record of content presented to a user by at least one dynamic information source;
receiving a user information request relating to transient information previously presented to the user;
reconstructing data relating to the transient information responsive to the user information request; and
presenting reconstructed data to the user.

20. The system of claim 19, wherein the operations further comprise:
maintaining a user profile responsive to past user behavior; and
using the user profile to assist in reconstructing the transient information.

21. The system of claim 20, wherein the operations further comprise drawing inferences regarding user context from the user information request and responsive to the user profile.

22. The system of claim 21, wherein reconstructing comprises identifying a proposed transient content query response, responsive to the record and the inferences.

23. The system of claim 19, wherein reconstructing data comprises:
retrieving stored transient information;
retrieving continuously presented information from an external source as indicated by a stored link; and
combining the stored transient information with the continuously presented information.

24. The system of claim 23, wherein reconstructing comprises:
interfacing with an inferencing engine to identify a context for a stored item responsive to a user profile; and
retrieving stored time stamp, indexing and/or metadata information to help identify specific data corresponding to the user request.

25. A system comprising:
at least one user interface;
at least one data storage apparatus;
at least one data processing device adapted to carry out operations, the operations comprising:
running a proxy between a user and a network;
responsive to the proxy, processing content experienced by the user, including differentiating according to whether such content is transient or expected to be available at a future time; and
storing transient content for later retrieval by the user.

26. The system of claim 25, comprising storing at least one of time stamp data, index data, and metadata associated with the transient content.

27. The system of claim 25, comprising building or updating a user profile based on results from the proxy.

28. A computer-readable medium embodying computer program code readable by at least one data processing device and adapted to cause the device to carry out operations, the operations comprising:
maintaining a record of content presented to a user by at least one dynamic information source;
receiving a user information request relating to transient information previously presented to the user;
reconstructing data relating to the transient information responsive to the user information request; and
presenting reconstructed data to the user.

29. The medium of claim 28, wherein the operations comprise:
maintaining a user profile responsive to past user behavior; and
using the user profile to assist in reconstructing the transient information.

30. The medium of claim 29, wherein the operations comprise drawing inferences regarding user context from the user information request and responsive to the user profile.

31. The medium of claim 30, wherein reconstructing comprises identifying a proposed transient content query response, responsive to the record and the inferences.

32. The medium of claim 28, wherein reconstructing data comprises:
retrieving stored transient information;
retrieving continuously presented information from an external source as indicated by a stored link; and
combining the stored transient information with the continuously presented information.

33. The medium of claim 28, wherein retrieving stored transient information comprises:
parsing a user request;
interpreting the user request; and
identifying a context for locating items responsive to a user profile.

34. The medium of claim 28, wherein reconstructing comprises:
interfacing with an inferencing engine to identify a context for a stored item; and
retrieving stored time stamp, indexing and/or metadata information to help identify specific data corresponding to the user request.

35. A computer-readable medium embodying computer program code readable by at least one data processing device and adapted to cause the device to carry out operations, the operations comprising:
running a proxy between a user and a network;
responsive to the proxy, processing content experienced by the user, including differentiating according to whether such content is transient or expected to be available at a future time; and
storing transient content for later retrieval by the user.

36. The medium of claim 35, comprising storing at least one of time stamp data, index data, and metadata associated with the transient content.

37. The medium of claim 35, comprising building or updating a user profile based on results from the proxy.

38. The medium of claim 37, comprising:
grouping content experienced by the user to yield groups of content;
linking the groups of content to a current user context; and
wherein the building or updating is responsive to the grouping and linking.

39. A computer-readable medium embodying computer program code readable by at least one data processing device and adapted to cause the device to carry out operations, the computer code implementing modules comprising:
at least one user interface;
at least one data storage apparatus;
at least one data processing device comprising:
a user management module for interfacing with a user and operating as a proxy between the user and a network;
an information processing module for
distinguishing transient from non-transient content;
causing storage of transient content;
causing storage of a link to non-transient content; and
adding at least one of time stamping, indexing, and metadata to stored transient content;
a data source management module for
interfacing with data sources;
storing transient content responsive to the proxy and the information processing module; and
storing links to non-transient content responsive to the proxy and the information processing module;
a profile adaptor for
grouping information shown to the user by at least one of time shown, type, and data source;
linking identified groups to a current user context; and
building or updating a user profile responsive to the grouping and linking;
an inference engine for
parsing user search requests;
interpreting user search requests; and
identifying user context responsive to the parsing, the interpreting, and the user profile information; and
a search engine for
interfacing with a profile adaptor to retrieve user profile information;
interfacing with the inference engine to identify the current user context;
interfacing with data stored by the information processing module to identify data to be retrieved from storage or external data sources;
retrieving data from the data source management module; and
combining retrieved data for presentation to the user.
